(19) United States
(12) Patent Application Publication
(10) Pub. No.: US 2001/0044853 A1
(43) Pub. Date: Nov. 22, 2001

(54) Information page structure, computer readable medium which has recorded information page display data, information presenting device, information page printing device and information presenting method which uses this information page printing device

(76) Inventor: Shunichi Tsuchida, Tokyo (JP)

Correspondence Address: BROWN PINNISI & MICHAELS, 400 M & T BANK BUILDING, 118 NORTH TIOGA ST, ITHACA, NY, 14850

(21) Appl. No.: 09/826,124

(22) Filed: Apr. 4, 2001

(30) Foreign Application Priority Data
Apr. 4, 2000 (JP) 2000-102615

(51) Int. Cl. G06F 15/16

(52) U.S. Cl. 709/245; 709/205; 709/203

(57) ABSTRACT

The invention provides methods and apparatus to entice a viewer of information to the information of a presenter of information so that a viewer of information will intently scrutinize the information that a presenter of information presents. A presenter of information displays address-related information 2 concerning the addresses of other pages where information that is desired by a viewer of information is located, in a portion of an information page 1 in the structure of this information page 1 that the presenter of information wants a viewer of information to view so that these addresses cannot be acquired and learned in a cursory glance.

### BACKGROUND OF THE INVENTION

1. Field of the Invention

The present invention pertains to the field of information processing, It concerns the configuration of information pages, computer readable media which record information page data, information presenting devices, printing devices for information pages, and a method of providing information using these printing devices for information pages, and concerns particularly a method for definitely having a viewer of information scrutinize information provided by an information presenter.

2. Description of Related Art

Advertisements on the Internet which rely on computer systems at this point in time use a method called “banner advertising”. These appear as a portion of a page in the form of name banners displayed in horizontal strips in the home page of a company or an individual.

When the general consumer who companies want to view advertisements, view the home page of a company or an individual, the viewer will not view the home page of the advertiser until he or she voluntarily shows interest in these banner advertisements and clicks on the banner.

However, in the previously noted example of prior art, it is well known that a viewer will not click if he or she does not want to. In addition, the advertisers and the creators of the banners think of how to capture the attention of the consumer with these banners and make the images of the banners move, use the expression which will attract the interest of the viewer and repeat this, by trial and error. Yet we do not deny that there is skepticism with respect to the effect of Internet advertising.

Advertisers with banner advertisements who rely on presentation of advertisements to individuals contract to pay a fee to the party presenting the advertisement each time a banner is clicked. So that naturally one might think that these disturbing people are doing something improper in using us and our friends and forcing us to click on the banner for their pages.

### SUMMARY OF THE INVENTION

The present invention is for the purpose of enticing the viewer of information to the information of the information provider so that the viewer of information will thoroughly scrutinize the information that the information provider presents.

In order to achieve the above purpose the invention provides an information page structure which has information which a provider of information wants to cause a viewer of information to view. The information contains address-related information concerning addresses of other pages which have information which the previously mentioned viewer of information desires in a portion of the previously mentioned information page, so that the previously mentioned addresses will not be known at a glance.

If this is done, a viewer of information will look everywhere on the information page while viewing, and endeavor to try to find information concerning the addresses of these other pages because he or she wants to view other pages that he or she desires. Because of this, a provider of information can induce a viewer of information to definitely scrutinize information that he or she wants to cause a viewer of information to view and can definitely induce a viewer of information to be aware of product information noted therein.

Here an “information page” includes both something which is configured as display data on a computer and something which is displayed on an object such as paper media. “Addresses of other pages” refer to the location of other data in a computer system when these other pages exist as data in a computer system. For example, this would refer to the such things as the Uniform Resource Locator (URL) address of Web pages that one can view on the Internet. In addition, when the other page is written in material such as paper media, this would apply to the number of pages given to that page, as well as such things as the name and month of publication or the like of such things as magazines and other publications that page contains, or would apply to such things as the name and location of the shops where that paper media are located.

When the “address” is an address in a computer system, it may be configured by information of the relative address seen from the address of an information page which one is presently viewing. For example, if the address of information which one is presently viewing is http://www.tokkyo.com/index.htm/ and the address of the other page is http://www.tokkyo.com/index.htm/hatumei/ the address of the other page which is concealed in the information may simply be “hatumei.” While “to view” is used, it is used in the broader sense of this term without regard to whether viewing of a page will be charged for or is free of charge. “So that will not be known at a glance” for example, for a Web page, refers to, of course, that the display of that Web page will not be known at a glance and means that it will not be known even if the source of that Web page is displayed and the addresses of links differ from the concealed links and banner advertisements which appear in the source.

Address-related information may be encoding information which encodes an address. A viewer of information may find the addresses of other pages by decoding this code.

Address-related information may also be a character string configuring information that a provider of information wants to induce a viewer of information to view. A viewer of information finds an address from characters configuring a character string.

Address-related information may also be image information which calls to mind an address. A viewer of information associates the address of another page from images displayed in an information page.

The images may be partitioned, suggesting the previously mentioned addresses, distributed and placed in numerous information pages. A viewer of information reconstitutes the parts of the partitioned image in his or her head and associates the address of another page from the reconstituted image.

In addition, address-related information may be cross word puzzle boxes and keys leading to addresses. A viewer of information may be lead to another address by information provided by a provider of information and, for example, by completing a cross-word puzzle based on vertical and horizontal keys and by a specific method from correctly solving that cross-word puzzle.

The invention also comprises a computer readable medium which has recorded display information of information pages, and a communications mechanism which receives specification of addresses of information pages recorded in this recording medium from an information page viewing device of the previously mentioned viewer of information and an information processing mechanism which reads information pages corresponding to addresses which this communications mechanism received and sends them to the previously mentioned information page viewing device via the previously mentioned communications mechanism.

An “information page viewing device” may appear, for example, as a client system which will be discussed later under embodiments. A “communications mechanism” is such things as an analog computer, terminal adapter, router or gateway etc. for connecting to a telecommunications network.

A viewer of information operates an information page viewing device (For example, a personal computer etc. which has a WWW browser installed), accesses an information page, finds other addresses concealed in that information page, and send the specification of that address. When the communication mechanism of an information presenting device receives the specification of this address it reads the page corresponding to the address specified from a storage mechanism and sends it back to the information page viewing device.

The invention may also be embodied in a printing device configured to have a storage mechanism which stores the addresses of information pages of the invention, or the addresses of pages linked to these information pages and hints for finding the previously mentioned addresses of other pages concealed in these information pages and an information printing mechanism and a control mechanism which reads the previously mentioned addresses and hints from the previously mentioned storage mechanism and causes the previously mentioned printing mechanism to print them.

For example, it prints the address of an information page on the Web and hints for finding the addresses of other pages from this information page with a printing mechanism and presents this to a viewer of information. Or, it may print the addresses of these other pages themselves rather than hints for finding these other addresses. “Pages linked to information pages” refers to pages which contain linking information to these information pages.

The addresses of information pages and hints for finding the previously mentioned addresses of other pages from this information page are presented to a viewer of information displayed on a tag (price tag etc.) of a product, displayed on the package of a product, printed material inserted inside the packaging of a product (including novelty products), displayed in a product catalog, displayed in hanging advertisements in train and subway cars, displayed on shopping receipts, displayed in newspaper advertisements (including newspaper inserts) displayed on magazine pages, displayed in direct mail, as premiums for arcade games, displayed in the menus of eating and drinking establishments, displayed on Internet shopping invoices.

Incidentally, hints for finding the addresses of other information pages from the addresses of information pages and from this information page may also be presented to viewers of information in TV commercials and radio CM.

### BRIEF DESCRIPTION OF THE DRAWING

FIG. 1 shows a block diagram of the information presentation system which applies the present invention.

FIG. 2 shows a drawing of the configuration of an information page in the first or second embodiment.

FIG. 3 shows a drawing of the configuration of an information page in the third embodiment.

FIG. 4 shows a drawing of the configuration of an information page in the fourth embodiment.

FIG. 5 shows a drawing of the configuration of an information page in the fifth embodiment.

FIG. 6 shows a drawing of the configuration of an information page in the sixth embodiment.

FIG. 7 shows a drawing of the configuration of an information page in the sixth embodiment.

FIG. 8 shows a drawing of the configuration of an information page in the sixth embodiment.

FIG. 9 shows a block diagram of a printing device for information pages.

### DETAILED DESCRIPTION OF THE INVENTION

### First Embodiment

### Address Suggestion (1) with a Code

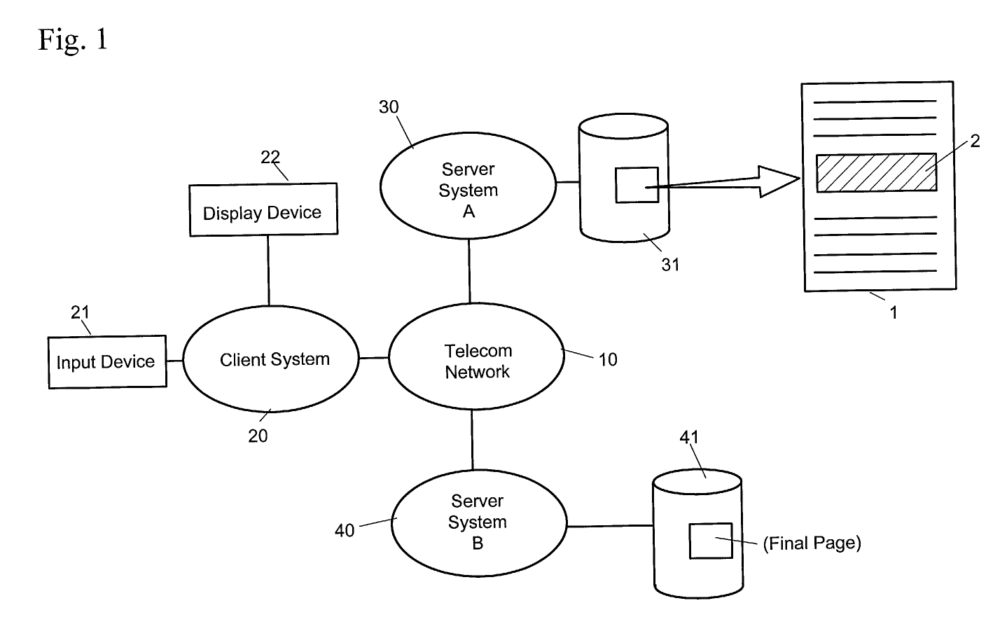

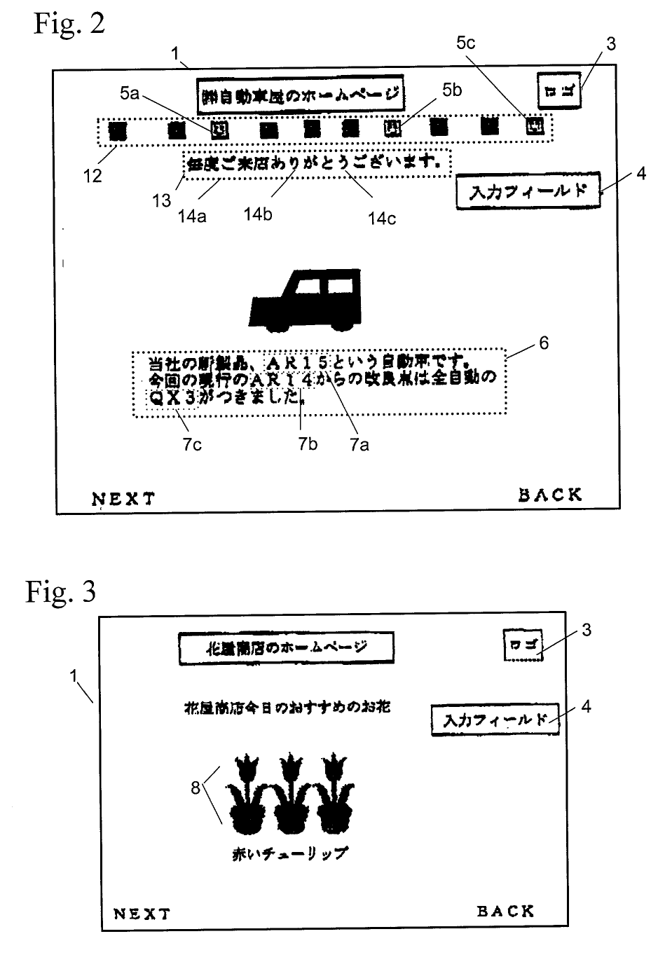

An embodiment of the present invention will be explained below based on FIGS. 1 and 2.

FIG. 1 is a block diagram of the information page presentation system which applies the present invention. Client system 20 and server systems 30 and 40 are connected to telecommunications network 10. In this embodiment telecommunications network 10 includes the Internet.

Client system 20 performs the transmission and receipt etc. of information via telecommunications network 10 with computer processing, receiving information from input device 21 and displaying information to a display device or the like.

In this embodiment input devices 21 are a keyboard and mouse (pointing device) and display device 22 is a computer display such as a CRT display etc.

Server systems 30 and 40 perform the transmission and receipt etc. of information via telecommunications networks with computer processing and access data bases 31 and 41 which have stored information.

In this embodiment the information of data bases 31 and 41 (information pages) are stored in the form of HTML files, XML files and ASP files etc. which can be viewed with a WWW browser loaded in client system 20. Then if one specifies a URL of a data base from client system 20 the pertinent file will be read from data bases 31 and 41 so that it will be sent to client system 20.

The information page stored in data base 31 contains primarily content for presenting companies' product information and advertising information etc. to information viewers and in addition to this contain address-related information 2 concerning addresses of other pages which have information that information viewers desire in a portion of this information page 1 so that this address will not be known at a glance.

In particular, in this embodiment, address-related information is contained as coded information which encodes this address.

FIG. 2 shows an example of an information page in this embodiment. In the upper portion of the page numerous square images are displayed arranged in a horizontal line 12. The square images include 2 types, and the 3^{rd}, 7^{th} and 10^{th} (the rightmost) images from the left (5a, 5b and 5c, respectively) are different from the other square images. In addition, the colors of the two types of images differs so that the 3^{rd}, 7^{th} and 10^{th} images from the left are blue while the other images are red. Furthermore, the string of characters “Maido goraiten arigatou gozaimasu” 13 [translated as “Thank you for patronizing our store”] is displayed below these square images arranged in a line. In actuality, the combination of this string of characters and the horizontal line of images configures a code. In the character string “Maido goraiten arigatou gozaimasu,” if one selects the 3^{rd}, 7^{th} and 10^{th} characters from the left (that is to say, the characters corresponding to where the colors of the images above differ), they are “go” 14a, “ri” 14b and “u,” 14c and these 3 romanized characters tied together as “goriu” is the address of another page. Assuming that the URL for an information page being viewed is “http://www.tokkyo.com/index/” the address of the other page is “http://www.tokkyo.com/index.html/goriu”.

The information viewer operated input device 21 of the client system, for example, inputs a specified URL in the URL input space of a WWW browser and requests that the server system send an information page. Client system 20 sends the request to send an information page to server system 30 via telecommunications network 10.

Server system 30 reads the information page 1 corresponding to the requested URL from data base 31 and sends it to client system 20 via telecommunications network 10.

Client system 20 displays the information page received on display device 22 and presents it to the information viewer. By virtue of this the information page that will be displayed will be the information page of previously noted FIG. 2.

In order to make the viewer of information know that the page that is displayed is an information page which has concealed the addresses of other pages according to this invention, logo 3 which has been systematized in advance is displayed. In addition, input field 4 for inputting addresses that the viewer of information found from this page is provided.

The viewer of information thoroughly scans the information of the information page displayed on display device 22, searches for the portion which he or she thinks might be a code and endeavors to find the address of other pages. In this process, the advertising information and product information etc. that a company presents is definitely viewed by the viewer of information and is imprinted on the memory of the viewer of information. The viewer of information guesses the portion which he or she thinks might be the code and when he or she discovers the addresses of the other pages, he or she tries to input that in input field 4. The program configuring information page 1, next after the URL of the information page presently being viewed, adds the address input in input field 4, configures a new URL and requests server system 30 for the next information page which corresponds to this new URL. Or the viewer of information may directly input the new URL in the URL input space of the WWW browser.

Client system 20 sends this request to server system 30 via telecommunications network 10. Server system 30 retrieves the information page corresponding to the requested URL from data base 31. The result of this is that when the search for the file corresponding to the specified URL (the next page) can be retrieved it sends it to client system 20. On the other hand, if the pertinent file cannot be retrieved it sends a page explaining that it cannot access the pertinent page to client system 20.

Client system 20 displays the page received on display device 22. When a new information page is displayed the viewer of information knows that the address he or she input in the input field earlier was correct and is challenged to search for hidden addresses in the newly displayed information page. On the other hand, if a message is displayed to the effect that it cannot access the pertinent page, he or she will know that the address input earlier was incorrect and once again is challenged to search for hidden addresses on the previous information page.

In this way, by a viewer of information correctly finding the addresses of other information pages from information pages, he or she can proceed to new information pages. Then present subscription pages etc. which bring benefits to the viewer of information are provided on a final page. The viewer of information by successively finding addresses of the next pages concealed in information pages arrives at a final page and at that point obtains information that is beneficial to the viewer of information.

In the present embodiment the final page to which one proceeds is controlled by a different server system 40 that the server system which presented information pages up to that point. Instead of the URL for server system 30 the URL for server system 40 which controls the final page is described in the program for the information page immediately preceding the final page. By managing the final page which is beneficial to the viewer of information with server system 40 which differs from the server system for the previous pages, the possibility that the viewer of information will improperly access the final page is reduced.

The embodiment explained above can get the viewer of information to definitely and carefully view the advertising information and product information etc. of a company.

### Second Embodiment

### Address Suggestion (2) with a Code

Next we shall explain a second embodiment of this invention based on FIG. 2. The system configuration is the same as in FIG. 1 so that redundant explanations will be dispensed with.

The character string 6 “Tousha no shinseihin, AR15 to iu jidousha desu. Konkai no genko no AR14 kara no kaizenten wa zenjidousha no QX3 ga isukimashita.”[Translated as: “This is our company's new product, the AR15 automobile. With respect to the improvements from the present model AR14, the QX3 of all automobiles has all of them”]. This character string is the address-related information 2 in this embodiment. That is to say, the address of the next page is contained in this character string.

If this character string is separated into words it becomes “tousha” “shinseihin” “AR15” “jidousha” “konkai” “genko” “AR14” “kaizenten” . . . . and compared with the portions of the horizontal line of images in the upper part of the page explained in the first embodiment where the colors differ, if the 3^{rd}, 7^{th} and 10^{th} words from the left are extracted, they are “AR15” “AR14” and “QX3” (7a, 7b and 7c, respectively). Connected they become “AR15AR14QX3” and this is the address of the next information page. Even if done this way the same operating effect as in the first embodiment can be obtained.

### Third Embodiment

### Address Suggestion with Image

Next we shall explain a third embodiment of the present invention based on FIG. 3. The system configuration is the same as in FIG. 1 so that redundant explanations will be dispensed with.

Images of 3 tulips 8 are shown in the information page shown in FIG. 3. The display is of red tulips. The image of these 3 red tulips is address-related information 2.

If the viewer of information associates keywords such as “3”, “three” , “tulip”, “red”, or “flowerpot”, or the Japanese words “san” [three], “mitsu” [three], “hachi” [container], “hana” [flower], “aka” [red], “hatiue” [plant in pot], from the image of red tulips as the address of the next information page he or she inputs them in input field 4. If the address input is correct he or she can advance to the next information page.

Even if done this way the same effect as in the first embodiment can be obtained.

### Fourth Embodiment

### Address Suggestion with Quiz

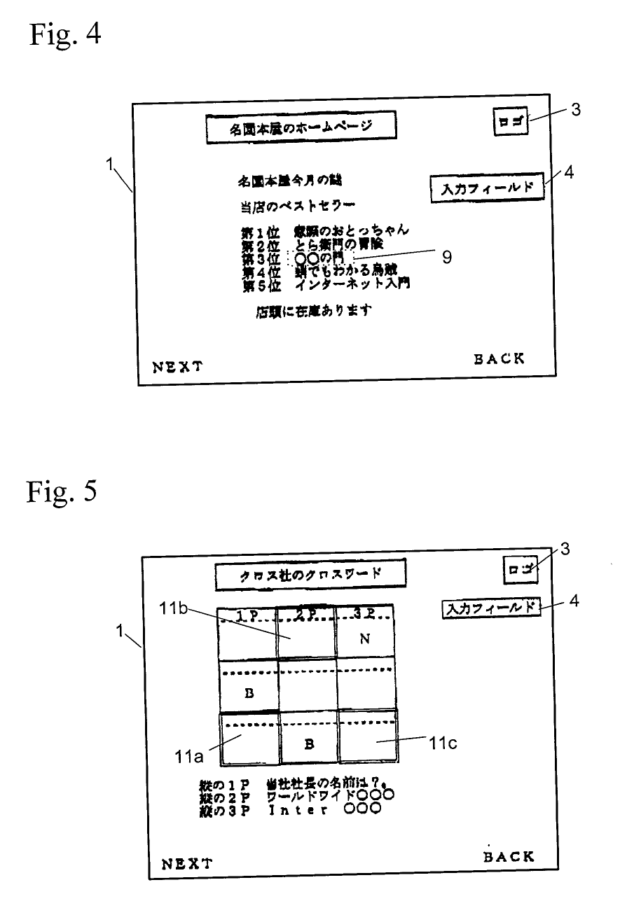

Next we shall explain a fourth embodiment of this invention based on FIG. 4. The system configuration is the same as in FIG. 1 so that redundant explanations will be dispensed with.

In the information page shown in FIG. 4, the first to fifth ranking publications are enumerated as “This store's best sellers.” Of these “blank blank no mon” 9 [blank blank “gate”] is displayed as the title of the third ranking publication, and thus the display of the title is incomplete. This incomplete title is address-related information 2 for the next information page. The viewer of information guesses what the “blank blank” portion constituting the correct title is and enters this in input field 4. Or he or she goes to a bookstore and obtains correct title information and enters it in input field 4.

For example, if the correct title of the publication is “Dendou no Mon” [Introduction to Electromotion] he or she enters “dendou” in input field 4. This is the address for the next information page. If the input address is correct he or she can proceed to the next information page. Even if done this way the same effect as in the first embodiment can be obtained.

Or the content of the quiz may be set so that one if forced to figure out the real criminal in a detective story with the correct name of the real criminal set as the address of the next information page. Or a general quiz can be used and the correct response made as the address of the next information page.

### Fifth Embodiment

Address Suggestion with Crossword Puzzle Suggestion

Next we shall explain a fifth embodiment of this invention based on FIG. 5. The system configuration is the same as in FIG. 1 so that redundant explanations will be dispensed with.

Cross word puzzle boxes (arrangement) and keys for solving them (Vertical 1P, Vertical 2P, Vertical 3P) are displayed in information page 1 shown in FIG. 5. This is the address-related information 2 for the next information page. The viewer of information also views another introductory page from the company etc. presenting this information page or actually visits the company etc. and gathers information that becomes hints for the cross-word puzzle. Then, based on the information gathered he or she solves the cross word puzzle and tries to fills in the blanks (it does not matter if one is actually unable to enter the characters in the crossword puzzle boxes on the page). Then, one extracts characters corresponding to specific crossword puzzle blanks specified in advance (the three blank boxes 11a, 11b and 11c enclosed with double lines) and the character string formed by lining up these 3 characters becomes the address of the next information page. Any number of addresses may be assumed by the order of lining up the 3 characters. By entering the correct address in input field 4 one may proceed to the next information page.

### Sixth Embodiment

### Address Suggestion with Images Distributed to Numerous Partitioned Pages

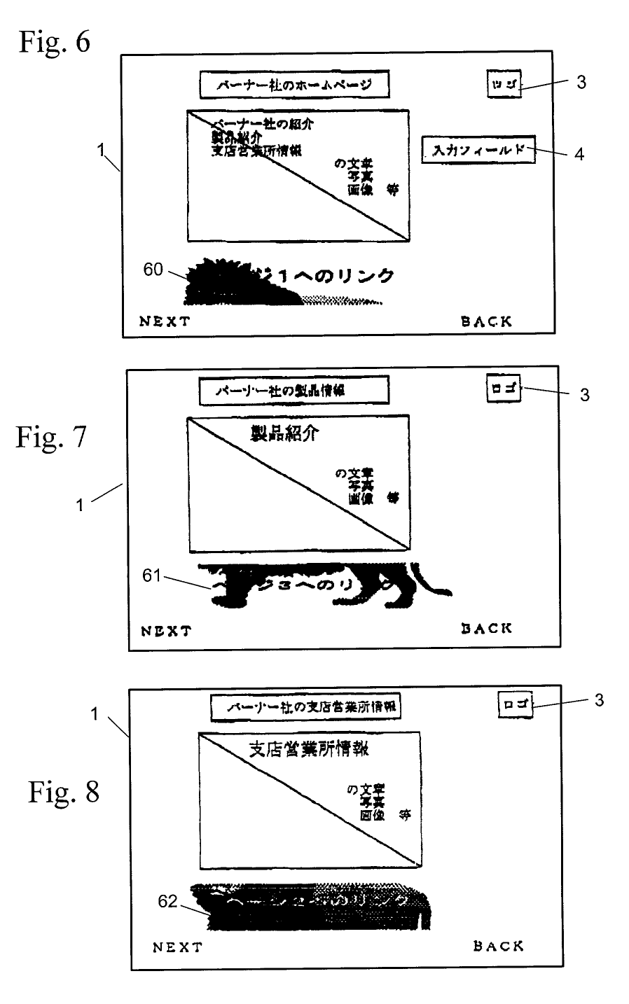

Next we shall explain a 6^{th} embodiment of the invention based on FIGS. 6 through 8 . . . . The system configuration is the same as in FIG. 1 so that redundant explanations will be dispensed with.

The uppermost part 60 of the image of a lion divided vertically into 3 parts is displayed on the information page 1 shown in FIG. 6. This image is address-related information 2. Similarly, the lowermost part 61 of the image of the same lion divided vertically into 3 parts is displayed in the information page 1 shown in FIG. 7. This image is address-related information 2. Further, the middle portion 62 of the image of the same lion divided vertically into 3 parts is displayed in the information page 1 shown in FIG. 8.

The viewer of information alternates between these three information pages and discovers that the partitioned image is that of a lion and with the expectation that this lion image is the address of the next information page enters “lion” and “raion” [in romanized letters, katakana or hiragana] etc. in input field 4 of FIG. 6. If this address is correct he or she advances to the next information page.

Even if done this way the same effect as in the first embodiment can be obtained.

### Presenting the Address of an Information Page, Presentation of Hints for Discovering Addresses of Other Pages

The service with each of the previously noted embodiments will not begin if the viewer of information does not access the page with the concealed address. Thus, the address (URL) of the information page providing these services can be presented to the viewer of information by other than a computer network. In addition, not only is the address of that information page provided, hints for discovering the address of the next information page from that information page are provided together with this address. And in certain circumstances the address of an information page and the address information of the next information page which is concealed in that information page is provided.

This, for example, would be presented to a viewer of information displayed on the tag (price tag etc.) of a product, displayed on the package of a product, printed material inserted inside the packaging of a product (including novelty products), displayed in a product catalog, displayed in hanging advertisements in train and subway cars, displayed on shopping receipts, displayed in newspaper advertisements (including newspaper inserts) displayed on magazine pages, displayed in direct mail, as premiums for arcade games, displayed in the menus of eating and drinking establishments, displayed on Internet shopping invoices, as well as through television and radio broadcasts etc.

By doing this, a viewer of information will attentively view all information presented with interest and will listen attentively to broadcasts. Moreover, a viewer of information in order to obtain a hint and responses will visit shops etc. and aggressively shop on the Internet. This will cause a viewer of information to act aggressively seeking hints and responses.

By virtue of this, resources which have been scattered regardless of the needs of prospective customers as with catalog, insert advertising and direct mail, conversely will be positively desired on the part of the prospective customers and we can expect that it will result in a decrease in print media advertising, reduction in advertising expenses as well as conservation of paper resources. That is to say, it is something that will even contribute to the preservation of forests and the prevention of global warming.

In addition, sightseeing areas that are losing their attraction and shopping areas that are declining and closing due to the inroads made by large scale retailers etc., if used for specific areas, can expect customers to come from near and far and this may contribute to the revitalization of these areas.

### Printing Devices for Information Page Addresses and Hints

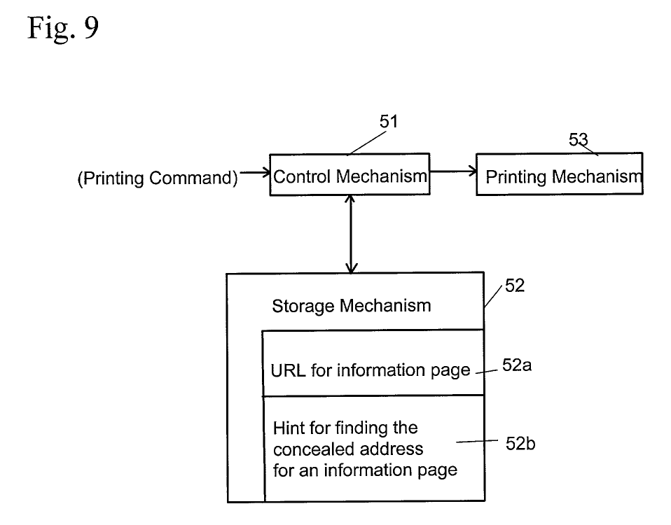

FIG. 9 is a block diagram of a printing device which prints addresses of the previously noted information pages and hints for finding addresses concealed therein.

Storage mechanism 52 and printing mechanism 53 are connected to control mechanism 51. When control mechanism 51 receives input of printing commands from outside by computer processing, it reads address (URL) 52a of an information page from storage mechanism 52 and hints 52b for finding addresses concealed in this information page, appends these to the main printing content (transaction amount information if it is a receipt, advertising information if it is an advertisement, price information etc. if it is a price tag), generates data for printing, inputs it to printing mechanism 53 and causes it to be printed on media such as paper. Storage mechanism 52, is a flash memory or EEPROM etc. and is such that it can hold memory content and can easily refresh memory content. Printing mechanism 53 is a traditional printing mechanism and regardless of the size of the mechanism may be any of a number of types of printer.

Here, in place of hint 52b, one may make it such that it stores, prints and presents the address of the next information page concealed in the information itself to the viewer of information. In addition, it may make the URL's of the pages to which this page is linked the object of printing and store them in storage device 52 and present to the viewer of information without making the URL of the information page which has the concealed address the object of printing.

The realization of this invention is not restricted to the respective embodiments which have been explained. The structure of the information pages which have concealed addresses may also be expressed and utilized on paper media materials etc. Client system 20 may be a portable terminal that can be connected to a telecommunications network such as i mode®, a device that is connected to a television etc. that can connect to a telecommunications network or may be a television game device such as a Playstation 2® or Dreamcast®. In FIG. 1 numerous server systems 30 may exist. That is to say, the sources supplying information pages 1 may scattered and exist in numerous server systems.

Because the present invention is configured and functions as described above, with it a viewer of information will wish to access other pages so that he or she will attentively scrutinize the content of information pages and it will be possible to register product information and advertising information which an information purveyor presents deeply in the memory of the viewer of information because the addresses of other pages which a viewer of information wants are concealed in an information page that a presenter of information wants to cause viewers of information to view so that they cannot be known at a glance.

In addition, this game-like nature charms and fascinates a viewer of information and the viewer of information will become such that he or she aggressively accesses the information pages that this service has provided. The opportunities for a viewer of information to access information presented by a purveyor of information will increase and not only will the viewer access the information, he or she will attentively scan the information provided therein.

In addition, by presenting the addresses of these information pages, hints and responses to a viewer of information online or through TV broadcasts and radio broadcasts the viewer of information attentively scans all information that a purveyor of information generates and will actively access stores etc. where that information is available. This can also increase the opportunities for the purchasing of products provided by the purveyors of information. Furthermore, by including the addresses of information pages and hints etc. in items traditionally distributed to consumers (insert advertisements, direct mail etc.), consumers will actively wish to have those distributed items and not only will it be possible to reduce advertising costs that have usually been incurred, it is expected that this will be linked to conservation of paper resources. That is to say, it is something which will go so far as to protect forests and prevent global warming and which provides a superior information page structure etc. not available in the past.

Table of Reference Numbers

| | |
|---|---|
| 1 | information page |
| 2 | address-related information |
| 3 | logo |
| 4 | input field |
| 5a, 5b, 5c | characters in line 12 which are |
| | address-related information |
| 6 | paragraph about car |
| 7a, 7b, 7c | data which are address-related |
| | information |
| 8 | picture of three tulips |
| 9 | line in list with blanks for |
| | address-related information |
| 10 | telecommunications network |
| | address for an information page |
| 11a, 11b, 11c | spaces in crossword |
| | containing address-related |
| | information |
| 12 | line of characters with address- |
| | related information |
| 13 | line of characters under line 12 |
| 14a, 14b, 14c | characters in line 13 which |
| | are address-related information |
| 20 | client system |
| 21 | input device |
| 22 | display device |
| 30, 40 | server system |
| 31, 41 | data base |
| 51 | control mechanism |
| 52 | storage mechanism |
| 52a | URL for information page |
| 52b | hint for finding the concealed |
| | address for an information page |
| 53 | printing mechanism |
| 60, 61, 62 | picture of lion which provides |
| | clue to address-related |
| | information |

What is claimed is:

1. An information page structure which has information which a presenter of information wants to cause a viewer of information to view, which contains address-related information comprising at least one address of another page in a in a form that said address will not be known at a glance.

2. The information page structure of claim 1, in which said address-related information is encoded information which encodes said address.

3. The information page structure of claim 1, in which said address-related information is embedded in a character string constituting information that said presenter of information wants to cause a viewer of information to view.

4. The information page structure of claim 1, in which said address-related information comprises at least one image, and the address is made up of at least one keyword related to the image.

5. The information page structure of claim 4, in which the image is partitioned into a plurality of image portions, and the image portions are placed in a plurality of information pages.

6. The information page structure of claim 1, in which said address-related information is contained in a plurality of boxes in a cross word puzzle.

7. A computer-readable medium having computer-executable instructions for displaying the information page structure of claim 1.

8. An information providing system for presenting an information page structure which has information which a presenter of information wants to cause a viewer of information to view, which page structure contains address-related information comprising at least one address of another page in a in a form that said address will not be known at a glance) the system comprising:
a computer-readable medium having computer-executable instructions for displaying the information page structure;
at least one server, coupled to the computer-readable medium, so that the server can retrieve the computer-executable instructions for a desired page from the computer-readable medium;
the server being connected to a telecommunications network, so that the server receives requests for information pages from a plurality of client systems connected to the network, and retrieves the computer-executable instructions for a desired page from the computer-readable medium and sends them to the client system via the telecommunications network to a viewer of information.

9. An information page printing device for presenting an information page structure which has information which a presenter of information wants to cause a viewer of information to view, which page structure contains address-related information comprising at least one address of another page in a in a form that said address will not be known at a glance, the device comprising:
a storage mechanism which stores at least a plurality of addresses of information pages and hints for finding addresses of other pages concealed in these information pages;
an information printing mechanism; and
a control mechanism which reads said addresses and hints from said storage mechanism and causes said printing mechanism to print them.

10. A method of providing information which a presenter of information wants to cause a viewer of information to view, comprising presenting the viewer with a page structure which contains address-related information comprising at least one address of another page in a in a form that said address will not be known at a glance.

11. The method of claim 10, in which said address-related information is encoded information which encodes said address.

12. The method of claim 10, in which said address-related information is embedded in a character string constituting information that said presenter of information wants to cause a viewer of information to view.

13. The method of claim 10, in which said address-related information comprises at least one image, and the address is made up of at least one keyword related to the image.

14. The method of claim 13, in which the image is partitioned into a plurality of image portions, and the image portions are placed in a plurality of information pages.

15. The method of claim 10, in which said address-related information is contained in a plurality of boxes in a cross word puzzle.

16. A computer-readable medium having computer-executable instructions for performing the method of claim 1.
